(19) United States
(12) Patent Application Publication
(10) Pub. No.: US 2018/0345711 A1
(43) Pub. Date: Dec. 6, 2018

(54) Laser Imaged Printing Plates

(71) Applicant: MacDermid Printing Solutions, LLC, Waterbury, CT (US)

(72) Inventors: Chouaib Boukaftane, Marietta, GA (US); Eric Lee, Woodstock, GA (US)

(21) Appl. No.: 15/608,210

(22) Filed: May 30, 2017

(51) Int. Cl. B41N 1/12; B41C 1/00

(52) U.S. Cl. CPC B41N 1/12; B41C 1/006

(57) ABSTRACT

Laser-imageable flexographic printing plates and a method of making same are disclosed. A thin masking layer comprising insoluble particles is laminated to a photopolymer layer. The insoluble particles in the masking layer roughen the photopolymer surface when the masking layer is laminated to the photopolymer surface. The masking layer is selectively ablated from the photopolymer using a laser operating at a selected wavelength to create an in situ negative. The resulting negative can be subjected to typical UV flood exposure and development.

### FIELD OF THE INVENTION

This invention relates to printing plates which can be made without using a negative. More specifically, it relates to a laser-imageable printing plate. Such plates are particularly useful for flexographic printing, but can be used for offset and lithographic printing.

### BACKGROUND OF THE INVENTION

Flexography is a method of printing that is commonly used for high-volume runs. Flexography is employed for printing on a variety of substrates such as paper, paperboard stock, corrugated board, films, foils and laminates. Newspapers and grocery bags are prominent examples. Coarse surfaces and stretch films can be economically printed only by means of flexography. Flexographic printing plates are relief plates with image elements raised above open areas. One type of flexographic printing plate resembles a transparent or translucent plastic doormat when it is ready for use. The plate is somewhat soft, and flexible enough to wrap around a printing cylinder, and durable enough to print over a million copies.

Such plates offer a number of advantages to the printer, based chiefly on their durability and the ease with which they can be made. Further improvements, to the degree of resolution (fineness of detail) which can be obtained as well as reductions in cost, would expand the usefulness of these plates. The present invention allows both increased resolution by use of laser processing, and reductions in cost through the elimination of the use of a negative to make the printing plate.

A typical flexographic printing plate as delivered by its manufacturer is a multilayered article made of, in order, a backing, or support layer; one or more unexposed photocurable layers; a protective layer or slip film; and a cover sheet. The backing layer lends support to the plate. It is typically a plastic film or sheet about 5 mils or so thick, which may be transparent or opaque. Polyester films, such as polyethylene terephthalate film, are examples of materials that can be suitably used as the backing. It may be anywhere from about 25-275 mils thick, and can be formulated from any of a wide variety of known photopolymers, initiators, reactive diluents, fillers, etc. In some plates, there is a second photocurable layer (referred to as an “overcoat” or “printing” layer) atop this first, base layer of photocurable material. This second layer usually has a similar composition to the first layer, but is generally much thinner, being on the order of less than 10 mils thick. The slip film is a thin (about 0.1-1.0 mils) sheet which is transparent to UV light that protects the photopolymer from dust and increases its ease of handling. The cover sheet is a heavy, protective layer, typically polyester, plastic or paper.

In normal use, the printer will peel the cover sheet off the printing plate, and place a negative on top of the slip film. The plate and negative will then be subjected to flood-exposure by UV light through the negative. The areas exposed to the light cure, or harden, and the unexposed areas are removed (developed). Typical methods of development include washing with various solvents or water, often with a brush. Other possibilities for development include use of an air knife or heat plus a blotter.

Analog exposure of the printing plate is usually carried out by application of a vacuum to ensure good contact between the negative and the plate. Any air gap will cause deterioration of the image. Similarly, any foreign material, such as dirt and dust between the negative and the plate results in loss of image quality.

Even though the slip films are thin and made from transparent materials, they still cause some light scattering and can somewhat limit the resolution which can be obtained from a given image. If the slip film were eliminated, finer and more intricate images could be obtained. Finer resolution would be particularly desirable for the reproduction of elaborate writing as in the case of Japanese characters, and for photographic images.

A negative can be a costly expense item. For one thing, any negative which is used for printing must be perfect. Any minor flaw will be carried through onto each printed item. As a consequence, effort must be expended to ensure that the negative is precisely made. In addition, the negative is usually made with silver halide compounds which are costly and which are also the source of environmental concerns upon disposal.

Given these considerations, it is clear that any process which would eliminate the use of the negative, or reduce the light scattering effects and other exposure limitations of the slip films, would yield significant advantages in terms of cost, environmental impact, convenience, and image quality over the present methods.

These advantages can be obtained by using a laser that is guided by an image stored in an electronic data file to create an in situ negative on a modified slip film (mask layer), and then exposing and developing the printing plate in the usual manner. As a result, the printer need not rely on the use of negatives and all their supporting equipment, and can rely instead on a scanned and stored image. Such images can be readily altered for different purposes, thus adding to the printer's convenience and flexibility. In addition, this method is compatible with the current developing and printing equipment, so expensive alterations to the other equipment are not required.

In this method of imaging a printing plate using a laser driven by a digital image, called digital imaging, a masking layer is first laminated on top of the photopolymer layer. The masking layer generally strongly absorbs both UV and Infrared light whereas the underlying photopolymer layer is only reactive with UV light. Once the masking layer is laminated to the photopolymer layer, an IR laser, driven by a digital image file, is used to selectively ablate the masking layer in the image desired. The printing element is then exposed to UV radiation such that the portions of the photopolymer layer that have been exposed by laser ablation react with the UV light and cure but the portions of the photopolymer layer which remain covered by the unablated portions of the mask layer remain uncured. The uncured photopolymer is then developed away revealing the relief image desired.

This invention relates to an improvement to the foregoing digital imaging process. Specifically, this invention relates to an improved digitally imaged printing plate with a roughened photopolymer surface which provides improved ink transfer and image reproduction upon printing.

### SUMMARY OF THE INVENTION

It is therefore an object of the present invention to provide a method of making a printing plate which does not require the use of a photographic negative.

Another object of this invention is to make a laser-imageable printing plate.

Yet another object of this invention is to provide a flexographic printing plate which has a roughened photopolymer surface which provides improved ink transfer and image reproduction upon printing. The objects of this invention can be accomplished by providing a UV absorbing and photoablatable masking layer for a photocurable printing element comprising
polymeric matrix;
a material which strongly absorbs both UV and IR light; and
particles with a size in the range of 0.25 microns to 35 microns.

Other objects and advantages of this invention will become apparent through the disclosure herein.

### DETAILED DESCRIPTION OF THE INVENTION

The present invention includes a method of making a laser imagable printing element. The laser imagable printing element of this invention comprises:
a) a substrate, preferably a flexible polymeric substrate which is translucent to UV light;
b) at least one photpolymer layer upon the substrate which cures upon exposure to

UV light; and
c) a masking layer upon the surface of the photopolymer layer which is furthest from the substrate, which masking layer comprises (i) a polymer matrix, (ii) a material which strongly absorbs both UV and IR light, and (iii) particles with a size in the range of 0.25 microns to 35 microns.

When the printing element is to be used, an IR laser is employed to selectively ablate, or remove, the masking layer. The uncured element is then flood-exposed to UV light. The areas where the mask was ablated will cure, or harden, upon exposure to the UV light. The areas where the mask was not ablated will remain uncured. The uncured areas can then be removed in the normal development process to yield a relief image.

The mask layer should be capable of absorbing infrared radiation and UV (actinic radiation). A single material or a combination of materials can be used to provide capabilities of absorbing infrared radiation and blocking actinic radiation.

The infrared/UV-absorbing material should have a strong absorption in the region of the infrared imaging radiation, typically 750 to 20,000 nm. Examples of suitable infrared/UV-absorbing materials include dark inorganic pigments such as carbon black, graphite, copper chromite, chromium oxides and cobalt chrome aluminate. Dyes are also suitable as infrared/UV-absorbing agents. Examples of suitable dyes include, poly(substituted)phthalocyanine compounds; cyanine dyes; squarylium dyes; chalcogenopyryloarylidene dyes; bis(chalcogenopyrylo)-polymethine dyes; oxyindolizine dyes; bis(aminoaryl)-polymethine dyes; merocyanine dyes; croconium dyes; metal thiolase dyes; and quinoid dyes. Infrared/UV-absorbing materials can be present in any concentration which is effective for the intended purpose. In general, for the organic compounds, concentrations of 0.1 to 80% by weight, based on the total weight of the infrared sensitive layer, have been found to be effective. The foregoing materials absorb both UV and IR light.

As photoinitiators used in the photopolymerizable layer(s) are sensitive to actinic radiation in the ultraviolet and/or visible region, the infrared sensitive layer must also absorb ultraviolet radiation. Thus, the masking layer should include a radiation-opaque material. Any material which prevents the transmission of actinic light to the photopolymerizable layer can be used in the masking layer as the UV radiation absorbing material. Examples of suitable UV radiation absorbing materials include dyes which absorb ultraviolet or visible radiation, dark inorganic pigments and combinations thereof. Preferred UV radiation absorbing materials are carbon black and graphite. The concentration of carbon black as the UV radiation absorbing material is chosen so as to achieve the desired optical density, i.e., so that the masking layer prevents the transmission of actinic radiation to the photopolymerizable layer. In general, a transmission optical density (OD) greater than 2.0 is preferred.

The dark inorganic pigments generally function as both infrared absorbing material and UV radiation absorbing material. Carbon black, graphite and mixtures thereof are particularly preferred dark inorganic pigments since they function as both the infrared absorbing agent and the UV radiation absorbing material in the masking layer. Metals and alloys can also function as both the infrared absorbing material and UV radiation absorbing material. To the extent that metals and alloys can be applied with the binder, they can also be used. Examples of metals include aluminum, copper, and zinc, and alloys of bismuth, indium and copper.

UV/IR absorbing materials can be present in any concentration that is effective for the intended purpose. The concentration of UV/IR absorbing materials which are needed decreases with increasing thickness of the masking layer. Thinner layers are preferred for higher ablation efficiency. In general, a concentration of 1-70% by weight, and preferably 10-60% by weight, based on the total weight of the masking layer can be used.

A dispersant is generally added when a pigment is present in the masking layer in order to disperse the pigment. A wide range of dispersants is commercially available. Useful A-B dispersants are disclosed in U.S. Pat. Nos. 3,684,771; 3,788,996; 4,070,388 and 4,032,698. The dispersant is generally present in an amount of about 0.1 to 10% by weight, based on the total weight of the layer.

The binder for the polymeric matrix of the masking layer should satisfy several requirements. (1) The binder should be removed or substantially removed by the heat generated by the infrared laser (2) The binder should be removable from the surface of the photopolymerizable layer after exposure to actinic radiation. (3) The binder should be one in which the other materials in the masking layer can be uniformly dispersed. (4) The binder should be capable of forming a uniform coating on the photopolymerizable layer. Examples of materials which are suitable for use as the binder in the masking layer which is adjacent to the photopolymerizable layer include those materials which are conventionally used as a slip or release layer in flexographic printing elements, such as polyamides; polyvinyl alcohol; copolymers of ethylene and vinyl acetate; amphoteric interpolymers; cellulosic polymers, such as hydroxyalkyl cellulose, and cellulose acetate butyrate; polybutyral; cyclic rubbers; and combinations thereof. Amphoteric interpolymers IS are described in U.S. Pat. No. 4,293,635 which is hereby incorporated by reference. Other materials suitable as the binder include self-oxidizable compounds such as nitrocellulose and nitroglycerine; non-self-oxidizing polymers such as alkylcellulose (e.g., ethylcellulose), polyacrylic acids and metal alkali salts thereof; polyacetals; polyimides; polycarbonates; polyesters; polyalkylenes, such as polyethylenes and polybutylenes; polyphenylene ethers; and polyethylene oxides; polylactones; and combinations thereof. Preferred binders for the infrared sensitive layer are polyamides, polyvinyl alcohol, amphoteric interpolymers, alkylcellulose, cellulosic polymers particularly hydroxypropyl cellulose and hydroxyethyl cellulose, nitrocellulose, copolymers of ethylene and vinyl acetate, cellulose acetate butyrate, polybutyrals, cyclic rubbers, and combinations thereof. Binders are generally present in amounts from 40% to 90% by weight, based on the total weight of the masking layer.

Examples of the secondary binders suitable for use in the masking layer include substituted styrene polymers, such as polystyrene and polyalphamethylstyrene; polyacrylate and polymethacrylate esters, such as polymethylmethacrylate and polybutylmethacrylate; poly(vinyl)chloride; polyvinylidene chloride; polyurethanes; maleic acid resins; and copolymers of the above. Materials which aid in ablation are suitable for use as the secondary binder and include polymers which are thermally decomposable such as homo- and co-polymers of acrylates, methacrylates, and styrene; polycarbonates, polyisobutylene; polybutene; polyvinylacetate; and combinations thereof. Adhesion modifiers are suitable for use as the secondary binder and include copolymers of polyvinylpyrollidone and vinyl acetate, polyvinylpyrollidone, and copolymers of styrene and acrylic acid. The secondary binder can generally be present in amounts of 1 to 40% by weight, based on the total weight of the binder in the masking layer adjacent to the phopolymerizable layer.

In accordance with the present invention the masking layer should also contain particles which are insoluble in the polymeric matrix of the masking layer. These particles should be in the size range of 0.25 microns to 35 microns. Preferred examples of suitable particles include Orgasol 201 UD®, polyamide non-crosslinked particles, and Durastrength 440®, polyacrylic crosslinked particles, both available from the Arkema company. Inorganic particles such as silica can also be used. The particles should be essentially insoluble in the polymeric matrix. The mask layer can contain up to about 25% by weight of the insoluble particles. Preferably the solid content of the insoluble particles in the mask layer is between 20% and 25% by weight. The inclusion of insoluble particles in the masking layer roughens the photopolymer layer below when the masking layer is laminated to the photopolymer layer. This roughness remains behind on the subsequently cured portions of the photopolymer layer after the masking layer is selectively ablated and later developed off the plate.

The thickness of the masking layer should be in a range to optimize both sensitivity and opacity. The layer should be thin enough to provide good sensitivity, i.e., the masking layer should be removed rapidly upon exposure to infrared laser radiation. At the same time, the layer should be opaque enough so that the areas of the layer which remain on the photopolymerizable layer after imagewise exposure effectively mask the photopolymerizable layer from actinic radiation. In general, this layer will have a thickness from about 20 Angstroms to about 50 micrometers. It is preferred that the thickness be from 40 Angstroms to 40 micrometers.

The masking 1 ayer can be pre pared by conventional methods of combining the UV/IR absorbing agent with the binder. A preferred method for preparing the infrared sensitive composition is to precompound the UV/IR absorbing agent with a portion of the total amount of binder, and then add the remainder of the binder, i.e., additional binder, to the precompounded mixture. Adding of the precompounded mixture to the remaining portion of the binder encompasses diluting, mixing, and/or blending. At any point in the precompounding, a solvent such as 80/20 n-butanol/toluene can be used for dispersing the materials used in the diluting, mixing, and/or blending steps. This method is particularly effective when carbon black or graphite is the UV/IR absorbing agent. It is preferred that the UV/IR absorbing material is precompounded with the binder at about 30 to 70 parts per hundred (by weight) of the UV/IR absorbing material. The weight ratof precompounded mixture to the additional binder is preferably 1:5 to 5:1. This is done to ensure that the pigmented radiation absorbing material is well dispersed in the binder and that a uniform coating layer is acheived.

The photosensitive element of the invention can also include a temporary coversheet on top of the masking layer. The purpose of the coversheet is to protect the masking layer during storage and handling. The temporary coversheet can also serve as a temporary support for the application of the infrared sensitive layer. It is important that the coversheet be removed prior to exposing the masking layer to infrared laser radiation. Examples of suitable materials for the coversheet include thin films of polyester, polystyrene, polyethylene, polypropylene, polycarbonate, fluoropolymers, and polyamide. The photosensitive element of the invention is generally prepared by first preparing the photopolymerizable layer on the support and then applying the masking layer by coating or lamination techniques.

In principle, any of the known photocurable formulations can be used in the present invention. Polyurethanes, including acrylate polyurethanes, acid-modified acrylate polyurethanes, aminemodified acrylate polyurethanes, rubbers, including acrylonitrile rubbers, and di- and triblock copolymers such as those made from styreneisoprene and styrene-butadiene may be used. The amine-modified acrylate polyurethanes and styreneisoprene or styrene-butadiene di- and triblock copolymers are preferred. The foregoing materials can be referred to as binders. Generally the photpolymer comprises a binder, monomer(s) and a photoinitiator. An uncured printing plate made from such a photopolymer can withstand some exposure to the laser energy without incurring thermal damage.

Photoinitiators for the photocurable composition include the benzoin alkyl ethers, such as benzoin methyl ether, benzoin ethyl ether, benzoin isopropyl ether and benzoin isobutyl ether. Another class of photoinitiators are the dialkoxyacetophenones exemplified by 2,2-dimethoxy2-phenylacetophenone, i.e., Irgacure® 651 (available from Ciba-Geigy, Hawthorne, N.Y.); and 2,2-diethoxy-2-phenylacetophenone. Still another class of photoinitiators are the aldehyde and ketone carbonyl compounds having at least one aromatic nucleus attached directly to the carboxyl group. These photoinitiators include, but are not limited to, benzophenone, acetophenone, o-methoxybenzophenone, acenaphthenequinone, methyl ethyl ketone, valerophenone, hexanophenone, alpha-phenylbutyrophenone, p-morpholinopropiophenone, dibenzosuberone, 4-morphol inobenzophenone, 4-morpholinodeoxybenzoin, p-diacetylbenzene, 4-aminobenzophenone, 4′-methoxyacetophenone, benzaldehyde, alpha-tetralone, 9-acetylphenanthrene, 2-acetylphenanthrene, 10-thioxanthenone, 3-acetylphenanthrene, 3-acetylindone, 9-fluorenone, 1-indanone, 1,3,5-triacetylbenzene, thioxanthen-9-one, xanthene-9-one, 7-H-benz[de]-anthracene-7-one, 1-naphthaldehyde, 4,4′-bis(dimethylamino)-benzophenone, fluorene-9-one, 1′-acetonaphthone, 2′-acetonaphthone, 2,3-butanedione, acetonaphthene, benz[a]anthracene 7.12 dione, etc. Phosphines such as triphenylphosphine and tri-o-tolylphosphine are also operable herein as photoinitiators. Benzophenone-based initiators are preferred. An example that is commercially available is Irgacure 651.

The photopolymer layer also generally comprises monomers. Typically acrylate and/or methacrylate monomers are used.

What is claimed is:

1. A laser imagable printing element comprising:
a) a substrate;
b) at least one photpolymer layer upon the substrate which cures upon exposure to UV light; and
c) a masking layer upon the surface of the photopolymer layer which is furthest from the substrate, which masking layer comprises (i) a polymer matrix, (ii) material which strongly absorbs both UV and IR light, and (iii) particles with a size in the range of 0.25 microns to 35 microns.

2. The element of claim 1 wherein said substrate is translucent to UV light.

3. The element of claim I wherein said at least one photopolymer layer comprises a binder, a monomer and a photoinitiator.

4. The element of claim 3 wherein said binder comprises a material selected from the group consisting of polyurethane, acrylonitrile rubber, a diblock or triblock copolymer made from styrene-isoprene or styrene-butadiene, and combinations thereof.

5. The element of claim 1 wherein the polymer matrix comprises a polyamide.

6. The element of claim 1 wherein the polymer matrix comprises a cellulosic polymer.

7. The element of claim 6 wherein the polymer matrix comprises hydroxypropyl cellulose.

8. The element of claim 1 wherein the particles are insoluble in the polymer matrix.

9. The element of claim 1 wherein the particles comprise a material selected from the group consisting of polyamide and polyacrylic.

10. A method of preparing a laser imagable printing element comprising:
a. providing a substrate;
b. coating at least one photpolymer layer upon the substrate which at least one photpolymer layer cures upon exposure to UV light; and
c. laminating a masking layer upon the surface of the photopolymer layer which is furthest from the substrate, which masking layer comprises (i) a polymer matrix, (ii) material which strongly absorbs both UV and IR light, and (iii) particles with a size in the range of 0.25 microns to 35 microns.

11. The method of claim 10 wherein said substrate is translucent to UV light.

12. The method of claim 10 wherein said at least one photopolymer layer comprises a binder, a monomer and a photoinitiator.

13. The element of claim 12 wherein said binder comprises a material selected from the group consisting of polyurethane, acrylonitrile rubber, a diblock or triblock copolymer made from styrene-isoprene or styrene-butadiene, and combinations thereof.

14. The method of claim 10 wherein the polymer matrix comprises a polyamide.

15. The method of claim 10 wherein the polymer matrix comprises a cellulosic polymer.

16. The method of claim 15 wherein the polymer matrix comprises hydroxypropyl cellulose.

17. The method of claim 10 wherein after step (c) the masking layer of the printing element is selectively ablated by a laser driven by a digital file containing the desired image stored in a digital manner.

18. The method according to claim 17 wherein after ablation the printing element is exposed to UV light which cures the photopolymer layer in areas exposed by ablation but leaves the unablated areas uncured.

19. The method according to claim 18 wherein the uncured areas of the photpolymer are developed away creating the relief image.

20. The element of claim 10 wherein the particles are insoluble in the polymer matrix.

21. The element of claim 10 wherein the particles comprise a material selected from the group consisting of polyamide and polyacrylic.
